(19) United States
(12) Patent Application Publication
(10) Pub. No.: US 2026/0111722 A1
(43) Pub. Date: Apr. 23, 2026

(54) DISTRIBUTED, MULTIMODAL LLM-BASED ADVANCED COMPRESSED SENSING

(71) Applicant: Dell Products L.P., Round Rock, TX (US)

(72) Inventors: Hoda Dehghan, Kanata (CA); Gwenael Poitau, Montreal (CA)

(21) Appl. No.: 18/919,971

(22) Filed: Oct. 18, 2024

(51) Int. Cl. G06N 3/08; G06N 3/0475

(52) U.S. Cl. CPC G06N 3/08; G06N 3/0475

(57) ABSTRACT

One example method includes receiving multi-modal data that includes different respective types of data from different respective devices of a network, fusing the multi-modal data together to generate fused data, providing the fused data to a multi-modal LLM (large language model), learning, by the multi-modal LLM, one or more sparsifying dictionaries for the multi-modal data and/or the fused data, generating, by the multi-modal LLM, sparse codes corresponding to the multi-modal data, and using the sparsifying dictionaries and sparse codes to reconstruct the multi-modal data initially received, and/or to perform one or more analyses on the multi-modal data.

### TECHNOLOGICAL FIELD OF THE DISCLOSURE

Embodiments disclosed herein generally relate to multi-modal data generated and gathered in network environments. More particularly, at least some embodiments relate to systems, hardware, software, computer-readable media, and methods, for the processing and use of network multi-modal data.

### BACKGROUND

In the rapidly evolving landscape of modern wireless communication systems, the efficient processing and analysis of data from a myriad of sources have become critical. With the advent of advanced technologies like autonomous vehicles, augmented and virtual reality devices, and a plethora of IoT (Internet of Things) gadgets, the volume, velocity, and variety of data generated by these devices have reached unprecedented levels. This surge in data, while being a potential goldmine of insights, poses significant challenges in terms of processing power, bandwidth, and latency. The crux of the problem lies in harnessing this multi-modal data effectively without overwhelming the network infrastructure or compromising on the real-time processing capabilities essential for applications like autonomous navigation or immersive AR/VR (augmented reality/virtual reality) experiences.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an architecture and workflow, according to one embodiment.

FIG. 2 discloses aspects of a method, according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to multi-modal data generated and gathered in network environments. More particularly, at least some embodiments relate to systems, hardware, software, computer-readable media, and methods, for the processing and use of network multi-modal data.

In general, example embodiments embrace architectures and methods for gathering, processing, evaluating, and using, multi-modal data of a network. The multi-modal data may be gathered from a variety of different devices operating in the network, and may concern both operations, state, and behavior of the devices, as well as operations, state, and behavior of the overall network.

One example embodiment of method may be implemented by a system as disclosed herein. In this example embodiment, the system operates by: initially preprocessing the data from various network sources such as, but not limited to, cameras, microphones, and an array of sensors; fusing this multi-modal data; feeding the preprocessed and fused data into an LLM (large language model), where a sparsifying dictionary is learned, by the LLM, for each data type, or a combined dictionary for fused data; and regularizing and constraining the learning process so as to ensure adherence to properties such as the Restricted Isometry Property (RIP) and Lipschitz continuity, and thereby establish and maintain robustness and stability of the LLM.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a large amount of multi-modal data may be efficiently processed and understood. An embodiment of a model (LLM) may be sufficiently portable that it can be deployed at edge devices in a network. An embodiment may enable edge devices to process data locally, rather than having to offload the data to a central node, for example, for processing. An embodiment may operate to maximize a sensed data rate, while also maintaining a fixed sensing time. An embodiment may operate to preserve the geometric properties of collected data, so as to prevent significant distortion during compression and recovery of the data. An embodiment may operate to maintain a stability and sensitivity of the output, relative to the input data, of a model to maintain the quality of the data through compression and decompression processes performed by the model. Various other advantages of one or more example embodiments will be apparent from this disclosure.

### A. Aspects of an Example Context for One Embodiment

The following is a discussion of aspects of a context for various embodiments. This discussion is not intended to limit the scope of the claims or this disclosure, or the applicability of the embodiments, in any way. Reference is made in the following discussion to the documents listed hereafter, each of which is incorporated herein in its respective entirety by this reference:
[1] L. He and L. Carin, “Exploiting Structure in Wavelet-Based Bayesian Compressive Sensing,” in IEEE Transactions on Signal Processing, vol. 57, no. 9, pp. 3488-3497 Sep. 2009.
[2] Z. Zhang, Y. Xu, J. Yang, X. Li and D. Zhang, “A Survey of Sparse Representation: Algorithms and Applications,” in IEEE Access, vol. 3, pp. 490-530, 2015.
[3] H. Palangi, R. Ward and L. Deng, “Distributed Compressive Sensing: A Deep Learning Approach,” in IEEE Transactions on Signal Processing, vol. 64, no. 17, pp. 4504-4518, 1 Sep.1, 2016.
[4] S. Khobahi and M. Soltanalian, “Model-Based Deep Learning for One-Bit Compressive Sensing,” in IEEE Transactions on Signal Processing, vol. 68, pp. 5292-5307, 2020.
[5] Z. Luo, J. Liang and J. Ren, “Deep Learning Based Compressive Sensing for UWB Signal Reconstruction,” in IEEE Transactions on Geoscience and Remote Sensing, vol. 60, pp. 1-10, 2022.

Compressed sensing has emerged as a transformative paradigm in signal processing, profoundly impacting how data is acquired, compressed, and reconstructed across a spectrum of domains. This technique hinges on the principle that sparse or compressible signals can be recovered from far fewer measurements than what traditional sampling theories dictate. Over the years, the field has seen a proliferation of methodologies and technologies, each tailored to harness the unique characteristics of various data types. The journey from the inception of CS to its current state has been marked by significant technological milestones and innovative approaches, shaping the landscape of data processing and analysis.

Initially, compressed sensing predominantly leveraged mathematical constructs like wavelet transforms and Fourier analysis. These techniques were instrumental in representing signals in a sparse domain, where most coefficients are zero or near-zero, and only a few hold significant values. For instance, in the realm of image data, wavelet-based compression was a cornerstone, enabling effective representation and compression by tapping into the inherent sparsity of images in the frequency domain. Similarly, audio compression saw the utilization of Fourier transforms to convert signals into a domain where they could be sparsely represented and efficiently compressed [1].

As the field matured, the focus shifted towards more sophisticated and adaptive methods. Sparse representation became a key concept, leading to the development of algorithms designed to reconstruct signals from a minimal set of linear, non-adaptive measurements. Techniques such as total variation minimization gained traction, particularly for image data, leveraging the sparsity in gradient domains and assuming that images typically exhibit a piecewise-constant structure [2].

The advent of machine learning and, subsequently, deep learning, marked a new era in compressed sensing. These technologies brought forth the potential to learn the measurement matrices adaptively from the data, a stark departure from the reliance on fixed or random matrices. Deep learning, especially with architectures like convolutional neural networks, began to redefine the landscape. These models could learn end-to-end mappings from compressed measurements to reconstructed signals, offering performance that often surpassed traditional sparse coding-based approaches [3]-[5].

However, the integration of domain-specific knowledge into the signal reconstruction process has emerged as a pivotal strategy. This approach involves embedding an expert understanding of the signal characteristics directly into the reconstruction algorithm, thereby enhancing both the quality and robustness of the reconstructed data. By leveraging this domain-specific knowledge, some models may more effectively interpret and process the intricate patterns within the data, leading to more accurate and reliable reconstruction outcomes.

From leveraging basic mathematical transforms to harnessing the power of deep learning, then, compressed sensing has continually pushed the boundaries of what may be possible in signal processing, paving the way for approaches that may operate to capture and reconstruct the essence of data in an increasingly digital world.

### B. Overview of Aspects of an Embodiment

### B.1 Introduction

To address challenges such as those noted herein, one embodiment may comprise a distributed multi-modal generative model integrated within a compressed sensing framework. This approach employs advanced machine learning techniques, particularly leveraging the capabilities of Large Language Models (LLMs) and generative neural networks, to efficiently process and understand the deluge of data that may be obtained from a network. One element of this approach is a sophisticated LLM-based sparsifying dictionary learning model, which is adept at handling high-dimensional, multi-modal data. This LLM, or simply ‘model,’ not only learns to sparsify the data, reducing its dimensionality without significant loss of information, but also reconstructs the original data from these sparse representations with high fidelity.

One embodiment of a system operates by initially preprocessing the data from various sources such as cameras, microphones, and an array of sensors, and then fusing this multi-modal data together. The preprocessed and fused data is fed into the LLM model, where a sparsifying dictionary is learned for each data type or a combined dictionary for fused data. This learning process is regularized and constrained, ensuring adherence to properties such as the Restricted Isometry Property (RIP) and Lipschitz continuity, which may be important in establishing and maintaining the robustness and stability of the model.

Furthermore, to cater to the distributed nature of modern networks and edge computing paradigms, the model according to one embodiment is configured to be portable and efficiently deployable on edge devices. This approach addresses the challenges of computational resource constraints and data privacy concerns inherent in distributed environments. An embodiment may ensure that the edge devices can process data locally, reducing or eliminating the latency and bandwidth usage that would be required to send the data out for processing, while also synchronizing with central models in the cloud or at the edge, thus maintaining consistency and leveraging federated learning to improve the model collectively without compromising data privacy.

### B.2 Discussion

In the context of distributed compressed sensing within an integrated sensing, communication, and computation framework, the primary goal is to maximize the sensed data rate while maintaining a fixed sensing time. This approach involves leveraging the sparse nature of signals and utilizing advanced techniques in machine learning and signal processing. The proposed solution involves several key strategies and faces various challenges. Below is a detailed discussion on each part of one embodiment:
Use of Sub-Nyquist Sampling for Sparse Signals:
Sub-Nyquist sampling techniques are employed to sample sparse signals below the Nyquist rate, thereby reducing the amount of data that needs to be processed and transmitted without losing crucial information. This is particularly beneficial in distributed sensing environments where bandwidth and energy resources are limited. Techniques such as Compressed Sensing (CS) allow the reconstruction of sparse signals from far fewer samples than traditionally required.
Learning a Dictionary for Sparse Representation:
In many applications, signals can be represented sparsely in a certain transform domain or dictionary. This sparsity is leveraged to reduce the number of measurements required.
   Application-Specific Dictionaries: For certain applications, dictionaries such as the Discrete Cosine Transform (DCT) or Wavelet Transform (WT) effectively sparsify data, especially images. These transforms ensure that the energy of the signal is concentrated in a few coefficients, making them amenable to compressed sensing.
   Machine Learning for Measurement Matrix Learning: For data types where a sparsifying dictionary is not readily available or known, machine learning techniques can be employed to learn the measurement matrix. This involves training a model to understand the underlying structure of the data and to define a domain in which the data is sparsely represented.
Generative Neural Networks for Data Mapping:
Generative models, particularly neural networks, can learn a mapping from a lower-dimensional data space to the targeted data distribution. This is particularly useful for reconstructing high-dimensional data from lower-dimensional measurements. The generative model acts as a learned decoder, mapping compressed measurements back to the original high-dimensional space. While ML-based approaches offer significant potential, they may come with challenges:
   Model Complexity and Overfitting. Particularly, deep learning models, particularly generative models, are complex and require substantial data for training. In some circumstances, there may be a risk of overfitting to the training data, which can lead to poor generalization to new, unseen data.
   Computational Resources: The training and deployment of these models require significant computational resources, which may be a constraint in distributed sensing environments.
Distributed Generative Models:
Proposed distributed generative models can help in scaling the approach to larger networks. Challenges in this domain include:
   Communication Overhead: Ensuring that the distributed models are in sync and that the communication overhead does not negate the benefits of distributed processing.
   Data Privacy: In distributed settings, data privacy becomes a concern.

Techniques like federated learning can be employed to train models without exchanging raw data.
Imposing Problem Constraints:
Finally, to ensure robust and stable signal recovery, certain mathematical conditions are imposed in an embodiment, namely:
   Restricted Isometry Property (RIP): For the measurement matrix, which acts as an encoder in this context, the measurement matrix should meet the RIP. This property ensures that the distances between the signals are approximately preserved in the compressed domain, which may be important for accurate reconstruction.
   Lipschitz Continuity on the Decoder: This is a mathematical condition that ensures the stability of the decoder, which may comprise a neural network in ML-based approaches. This means that the output of the decoder does not change drastically with small changes in the input, which may enable the model to be robust, or resistant, to measurement noise and perturbations.

### B.2.1 Distributed Multi-Modal Generative Model for Compressed Sensing

An embodiment may operate to harness the power of Generative Neural Networks (GNN) and a multi-modal LLM framework. An approach according to one embodiment addresses the challenges of working with high-dimensional data by effectively learning and mapping from a lower-dimensional data space to the targeted high-dimensional data distribution. Thus, an embodiment has the ability to reconstruct high-dimensional data accurately and efficiently from lower-dimensional measurements, a process facilitated by the generative model acting as a learned decoder.

A feature of an architecture according to one embodiment is the use of a “multi-modal foundation model,” which comprises a versatile framework designed to incorporate various generative techniques, including LLMs diffusion model principles, among others, that may arise in the future. In an embodiment, this approach enables the system to adeptly manage and interpret a vast array of data types, a function for Radio Access Network (RAN) applications. By leveraging the multi-modal foundation model, the system is capable of processing and understanding diverse data forms, whether those data forms be textual, audio, visual, or any combination of these.

Additionally, an LLM according to one embodiment refines this data into a sparse, denoised representation. The potential integration of diffusion model principles, alongside other emerging generative architectures, enhances this capability by filtering out extraneous information. This ensures the data representation is not only sparse, but also of high quality and relevance, suited to the multifaceted nature of data modalities.

In an embodiment, the LLM transcends some conventional roles. By way of contrast with conventional approaches, an LLM according to one embodiment actively participates in the dictionary learning process, predicting the sparse coefficients of data representations directly. This means that the LLM is learning the measurement matrix or dictionary that best sparsifies the data. This direct prediction approach is an improvement over conventional methods in which the dictionary learning was a separate, often detached process.

While this ML-based approach, according to one embodiment, provides useful functionality in the arena of data processing, an embodiment may also bring challenges, particularly concerning model complexity and the risk of overfitting. Generative models are complex and demand extensive data for training. Overfitting to the training data can impair the model's ability to generalize to new, unseen data. Additionally, the computational resources required for training and deploying these models are substantial, which could pose constraints in distributed sensing environments.

To mitigate these challenges and scale the approach to larger networks, one embodiment comprises the use of distributed generative models. In more detail, feeding multi-modal data from various intelligent devices into an LLM enables the LLM to define a sparsifying matrix for each data type or combination of data involves a structured process. This process may comprise data preprocessing, feature extraction, and dictionary learning to achieve a sparse representation of the data. Further details concerning these components and functions are set forth below.

### B.2.1.1 Example Data Types and Preprocessing

I. Visual Data (from cameras):
   Preprocessing: Image normalization, resizing, and possibly converting to grayscale if color is not essential.
   Feature Extraction: Use Convolutive Neural Networks (CNNs) to extract features or create embeddings that capture essential visual information.
II. Audio Data (from microphones):
   Preprocessing: Noise reduction, normalization.
   Feature Extraction: Convert audio signals into spectrograms or use Mel-Frequency Cepstral Coefficients (MFCC) to capture the audio's essential characteristics.
III. Sensor Data (from autonomous vehicles, AR/VR headsets, IoT devices, for example):
   Preprocessing: Standardization of sensor readings, handling missing values or outliers.
   Feature Extraction: Apply time-series analysis or other signal processing techniques to extract meaningful patterns or features.
IV. Biometric Data (from AR/VR Headsets, Smart Glasses):
   Preprocessing: Normalize readings, handle sensitive data securely.
   Feature Extraction: Extract features such as, for example, pulse rate variability, gaze direction, or facial expressions.

### B.2.1.2 Data Fusion for Multi-Modal Inputs

Before feeding the data into the LLM model, these diverse data types may be integrated together. In one or more embodiments, data fusion may be implemented at various levels, such as, for example:
Feature-Level Fusion: Combine features from different modalities before inputting them into the model. This requires the features to be compatible in terms of scale and format.
Decision-Level Fusion: Make separate predictions using data from each modality and then combine these predictions. This method is useful when each modality contributes independently to the decision-making process.

### B.2.1.3 LLM for Sparsifying Dictionary Learning

1. Input to the LLM Model:
   The preprocessed and possibly fused multi-modal data is fed into the LLM. The LLM model is adept at handling high-dimensional and complex data, making it suitable for this task.
II. Sparsifying Dictionary Learning Process:
   The LLM, equipped with its large parameter space and deep architecture, is used to learn a sparsifying dictionary for each data type or a combined dictionary for fused data.
   The LLM learns to represent the input data as a sparse linear combination of the dictionary atoms. In an embodiment, this involves solving an optimization problem where a goal may be to minimize the reconstruction error, while enforcing sparsity in the coefficients.
III. Regularization and Constraints:
   To ensure the learned dictionary is robust and generalizable, regularization techniques are applied in fine-tuning phase.
   Additional constraints, such as the Restricted Isometry Property (RIP) and Lipschitz Continuity are incorporated into the learning process to ensure the quality of the sparse representation.

### B.2.1.4 Inputs of the Model

1. Sparse Codes:
   The model outputs sparse codes for the input data. These codes are efficient and compact representations, capturing the essential information from the multi-modal data.
II. Learned Dictionaries:
   The model also outputs the learned dictionaries for each data type or the fused data. These dictionaries contain the basis elements, also referred to as ‘atoms’ that, when combined together in a sparse manner, can reconstruct the input data that was provided to the model.
III. Reconstructed Data or Further Analysis:
   The sparse codes and dictionaries can be used to reconstruct the original data, denoise it, or perform further analyses such anomaly detection, pattern recognition, or decision-making based on the sparse representation.

Briefly then, a process according to one embodiment comprises preprocessing and fusing multi-modal data, feeding it into an LLM model for sparsifying dictionary learning, and then utilizing the learned dictionaries and sparse codes for data reconstruction or further analysis. This approach leverages the power of LLMs to handle complex and high-dimensional data, providing a robust and efficient way to represent and utilize multi-modal data from intelligent devices in wireless networks.

### B.2.2 Imposing Sparsifying Dictionary Constraints

In the realm of dictionary learning and decoder design, particularly within the framework of compressed sensing systems, the incorporation of mathematical constraints-specifically, the RIP and Lipschitz Continuity—may provide and enable various useful functionalities. These constraints are not arbitrary, but are chosen to ensure the integrity and optimal performance of the system. Within the LLM-based dictionary learning process is both strategic and deliberate, each constraint serves a specific purpose in the overall functionality of the system according to one embodiment.

It is noted however that an embodiment involves a specific phase of fine-tuning that diverges from conventional approaches to unsupervised learning associated with LLMs. A fine-tuning phase of one embodiment is configured to tailor the LLM to the unique requirements of compressed sensing systems. Unlike conventional LLM training, which generally relies on unsupervised learning from vast datasets to generate or understand text, the process according to one embodiment comprises a reinforcement learning loop. This loop is used for adapting the model to perform specific tasks related to dictionary learning and decoder design. The reinforcement learning (RL) mechanism used in the fine-tuning phase is guided by a loss function that models RIP and Lipschitz constraints. This loss function is a component of the training process, ensuring that the fine-tuned model not only learns to generate useful representations but also does so in a way that minimizes loss, thereby satisfying the required constraints.

In an embodiment, each mathematical constraint-RIP and Lipschitz Continuity-plays a role in a fine-tuning process. The RIP constraint ensures that the model preserves the geometric properties of the data, preventing significant distortion of the data during compression and recovery. Meanwhile, Lipschitz Continuity provides a measure of stability and sensitivity of the model output relative to the input to the model, which maintains the quality of the data through the compression and decompression processes. The incorporation of these constraints, along with the targeted fine-tuning phase, at least, distinguishes this approach from conventional LLM training, so as to enable achievement of the desired performance and integrity in compressed sensing systems.

### B.2.2.1 Application/Inclusion of RIP Constraint in LLM-Based Dictionary Learning

1. Integration During Training Phase: The RIP constraint plays a role during the dictionary learning phase, particularly in the training of the model. One of the functions of the RIP constraint is to enforce a specific property on the learned dictionary, ensuring that the distances between signals are preserved when they are sparsely represented. Mathematically, a matrix A satisfies the RIP condition of order k if there exists a constant δₖ, such that for all k-sparse signals x, the following inequality holds:

$$( 1 - {δ}_{k} ) {‖ x ‖}_{2}^{2} \leq {‖ Ax ‖}_{2}^{2} \leq ( 1 + {δ}_{k} ) {‖ x ‖}_{2}^{2}$$

To enforce this property during training, the RIP constraint is incorporated as a regularization term in the loss function of the model. This inclusion serves to guide the model towards a dictionary that inherently satisfies the RIP condition. The regularization term effectively penalizes the model if the learned dictionary deviates from this condition, ensuring that the model is biased towards learning representations that maintain the integrity of the signal structure.
The challenge in using the RIP condition directly in a loss function is that verifying whether a matrix A satisfies RIP is an NP-hard problem. However, it is possible to encourage a learned dictionary A to have properties that are generally associated with the RIP, such as promoting sparsity and ensuring that the matrix does not distort the length of signals excessively.
Example approach: Following is a conceptual approach to formulating a loss component that encourages RIP-like properties, where this approach may be referred to here in as “RIP-Inspired Regularization Term in the Loss Function.”
   a. Sparsity promotion:
      An embodiment may promote sparsity in the representation of data by adding a sparsity-promoting term to the loss function, like the &₁ norm of the coefficient matrix X when A is applied to data points D, i.e., D=AX.
   The loss component may be λ₁∥X∥₁ where λ₁ is a regularization parameter.
b. Distortion limitation:
   To ensure that the matrix A does not distort the length of signals too much, an embodiment may include a term that penalizes the deviation of ∥AX∥₂² from ∥X∥₂².
   One possible loss component for this could be λ₂(∥AX∥₂²−|X∥₂²), where λ₂ is a regularization parameter.
c. Pairwise distance preservation:
   Another aspect of RIP is preserving distances between distinct signals. One embodiment may encourage this by adding a term that penalizes changes in the pairwise distances of signals after transformation by A.
   For a batch of signals X, an embodiment may calculate pairwise distances for the original and transformed signals and then add a term such as:

$${{λ}_{3} \sum ( dist \{ {X}_{i} , {X}_{j} ) - dist ( {AX}_{i} , A {X}_{j} ) )}^{2}$$

where λ₃ is a regularization parameter.
Combining these, a conceptual loss function L that includes an RIP-inspired regularization term may look like:

$$L = {L}_{original} + {λ}_{1} {‖ X ‖}_{1} + {λ}_{2} ( {‖ AX ‖}_{2}^{2} - {‖ X ‖}_{2}^{2} ) + {λ}_{3} \sum {( dis t ( {X}_{i} , {X}_{j} ) - d i s t ( A {X}_{i} , A {X}_{j} ) )}^{2}$$

Here, L_{original} is the original loss function of the model, and the other terms are added to encourage properties associated with RIP. The λ parameters control the importance of each term and may need to be determined based on the specific application and through validation. It is noted that this approach does not necessarily guarantee that the learned dictionary A strictly satisfies the RIP condition, but it encourages properties in A that are desirable and in line with the spirit of the RIP condition. The adherence to RIP may still need to be validated post-training through additional checks or empirical evaluation, as verifying RIP directly is generally computationally infeasible for large matrices.
Post-Training Validation
   In one embodiment, after the model is trained, the adherence to the RIP condition does not conclude. Rather, the learned dictionary is then subjected to rigorous validation, a process that involves testing the dictionary's dictionary performance on random s-sparse vectors. This process may be used to confirm that the dictionary indeed preserves the distances between signals, so as to enable the faithful reconstruction of signals from their compressed representations.

### B.2.2.2 Inclusion of Lipschitz Continuity in Decoder Design

I. Stability in Decoder Algorithm: While the RIP constraint focuses on the dictionary learning phase, Lipschitz Continuity is employed in the configuration of the decoder, particularly when the decoder is realized in the form of a deep neural network. This constraint is used for ensuring that the mapping from the lower-dimensional latent space back to the original data space is stable and robust. Mathematically, a function ƒ is said to be Lipschitz continuous if there exists a constant L such that for all x and y, the following inequality holds:

$$‖ f ( x ) - f ( y ) ‖ \leq L ‖ x - y ‖$$

In the context of the decoder design, ensuring Lipschitz Continuity means imposing constraints on the neural network weights and choosing activation functions judiciously. Techniques such as weight constraints or spectral normalization are employed to ensure that the decoder behavior remains consistent and predictable across different inputs. This mathematical inclusion is used to maintain the stability of the network, ensuring that small variations in input do not lead to disproportionately large variations in the output, thereby preserving the integrity and fidelity of the reconstructed signals. This implies that changes in the output of the function, that is, the decoder output, are bounded by a constant multiple of changes in the input.
II. Architectural Considerations for Lipschitz Continuity: The architecture of the neural network, that is, the decoder, may be configured in a way that inherently respects the Lipschitz condition. This configuring of the decoder may involve selection and configuration of the network layers and activation functions.
   Controlled Weight Initialization:
   Initialize the weights of the neural network in a way that does not amplify the Lipschitz constant. Methods like Xavier or He initialization can be used as they are designed to maintain the scale of the gradients throughout the network.
   Use of Lipschitz-continuous Activation Functions:
   Ensure that the activation functions used in the neural network are Lipschitz continuous. For instance, ReLU (Rectified Linear Unit) is a popular choice as it is Lipschitz continuous with a Lipschitz constant of 1.
III. Imposing Lipschitz Constraint During Training: Enforce the Lipschitz constraint during the training of the neural network. This can be achieved through various techniques:
   Weight Clipping or Constraint: Apply a constraint on the weights of the network to ensure that they do not exceed a certain value, effectively controlling the Lipschitz constant of the network. This can be done by setting a maximum norm for the weights and clipping the weights if the maximum norm is exceeded during training.
   Spectral Normalization: Use spectral normalization, which normalizes the weight matrix of each layer by its largest singular value. This ensures that the spectral norm (a surrogate for the Lipschitz constant) of the layer's transformation does not exceed a specified value, thereby controlling the Lipschitz constant of the entire network.
   Gradient Penalty: Implement a gradient penalty in the loss function, which penalizes the network if the gradient norms for the output with respect to the input exceed a certain threshold. This encourages the network to learn functions that have bounded gradients, thereby indirectly enforcing Lipschitz continuity.
IV. Validation and Monitoring: After the incorporation of the Lipschitz continuity constraint, an embodiment may then validate and continuously monitor the behavior of the decoder during and after training:
   Monitor the Gradient Norms: During training, monitor the norms of the gradients of the output with respect to the input. This provides insight into whether the network respects the Lipschitz condition.
   Evaluate the Stability of the Decoder: After training, an embodiment may evaluate the decoder performance on test data, particularly focusing on the stability and robustness of the decoder to input perturbations. This helps in verifying if the Lipschitz continuity constraint is effectively manifested in the decoder behavior.

By meticulously incorporating the aforementioned operations into the design and training of an LLM-based decoder algorithm, an embodiment may ensure that the Lipschitz continuity constraint is effectively integrated, thereby enhancing the stability and robustness of the decoder in compressed sensing systems.

### C. Detailed Discussion of Aspects of One or More Embodiments

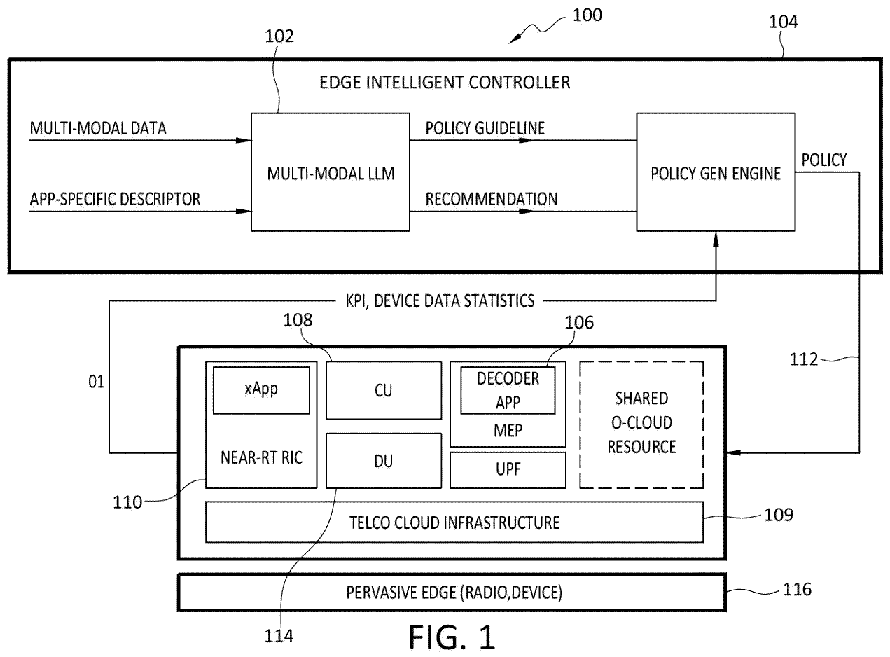

Following is a more in-depth exploration of the model architecture, application of constraints, design of the decoder, and deployment strategies, according to an embodiment. An embodiment may thus integrate advanced machine learning techniques with specific architectural considerations tailored for Radio Access Networks (RAN). The following sections delve into these components in detail as shown FIG. 1, which discloses a distributed multi-modal LLM-based advanced compressed sensing framework 100, or simply ‘architecture 100,’ according to one embodiment.

### C.1 Model Architecture: Multi-Modal LLM-Based Configuration

The example architecture 100 has a configuration that comprises a multi-modal LLM 102 that is proficient in understanding and processing a variety of data types. This adaptability can be important for RAN applications, which may encounter a broad spectrum of data forms. The multimodal capabilities of the architecture 100 may ensure that whether the data is textual, audio, visual, or any other type of data, or a combination of any of the foregoing, the system can process and interpret that data effectively.

One aspect of the architecture 100 is the integration of multi-modal LLM and diffusion models. In particular, the architecture 100 integrates a multi-modal LLM 102 with principles of diffusion models. This hybridization enables the system not just to understand different data types but to transform these into a sparse representation. The diffusion model principles aid in de-noising the data, ensuring that the representation is not just sparse, but also clean and devoid of irrelevant information.

Another aspect of the example architecture 100 is the direct prediction of sparse coefficients. In particular, the multi-modal LLM 102, which may be an element of an edge intelligent controller 104, is an active learner in the dictionary learning process, and is trained to predict the sparse coefficients of data representations directly. This approach means that the multi-modal LLM 102 is learning the measurement matrix or dictionary that best sparsifies the data, a task conventionally handled by separate algorithms or processes.

### C.2 Problem Constraints

In the landscape of dictionary learning and decoder design for compressed sensing systems, adhering to stringent mathematical constraints is useful. The RIP and Lipschitz Continuity serve as components in this mechanism, each playing a distinct role. For example, the RIP constraint is used during the training phase, guiding the learning of a reliable and efficient dictionary, while Lipschitz Continuity ensures the stability and robustness of the decoder during signal reconstruction. An examination of these constraints reveals the interplay between theory and practice, helping to ensure the overall integrity and performance of the system.

Application of the RIP constraint may involve various considerations, one of which is regularization in training loss function. That is, applying the RIP constraint is useful in ensuring the robustness of the learned dictionary. In the training phase for the model, a regularization term is incorporated into the loss function. This term quantitatively measures the deviation from the RIP condition, effectively guiding the model towards learning a dictionary that satisfies this property. Another consideration concerning the RIP constraint is validation against the RIP condition. In particular, post-training, the learned dictionary undergoes testing against the RIP condition. This involves assessing the dictionary performance on random s-sparse vectors, so as to help ensure that the dictionary preserves the distances between signals, which may be a requirement for accurate signal reconstruction.

With continued attention to FIG. 1, a decoder 106, or decoder app, may be provided that incorporates a Lipschitz Continuity constraint. In an embodiment, the decoder 106 may be an element of an MEP (Mobile Edge Platform), which enables low-latency cloud services. A UPF (User Plane Function) may also be provided which manages the routing and forwarding of user data traffic in 5G networks. In more detail, the decoder 106 may comprise an algorithm, which may be realized through a deep neural network (DNN) for example, is operable to map the low-dimensional latent representations back to the original data space. This process is used for reconstructing the data from its compressed form, ensuring the utility of the entire compressed sensing process. Regarding the implementation of the Lipschitz Constraint, ensuring Lipschitz continuity is used in an embodiment to enable the stability and robustness of the decoder 106. Thus, one embodiment employs weight constraints or spectral normalization techniques to meet this constraint. Moreover, the choice of activation functions may favor those that do not excessively increase the Lipschitz constant, thereby maintaining the stability of the network during its operations.

### C.3 Example Deployment Scenarios

In the dynamic and demanding environment of modern communication systems, the strategic deployment of computational resources becomes important. The deployment strategy for the multi-modal LLM 102 and the decoder 106 in the example architecture 100 is configured to ensure optimal utilization of computational resources while meeting the stringent performance and latency requirements of RAN. Thus, this section outlines deployment scenarios for both the multi-modal LLM 102 and the decoder 106, highlighting how each component is positioned within a network infrastructure to leverage its strengths and meet the system operational demands.

### C.3.1 Deployment of Multi-Modal LLM Unit

With regard first to optimal utilization of computational resources, the multi-modal LLM 102, is configured and operable to process and interpret a wide array of data types. To support its complex machine learning models, the multi-modal LLM 102 may be deployed in environments where computational resources are abundant. This includes placement within a Central Unit (CU) 108, or an edge cloud environment 109, for example. Such locales typically comprise substantial computational power, such as may be needed to support the operations of the multi-modal LLM 102.

Next, with continued reference to FIG. 1 and with regard to integration with a near-real time RAN Intelligent Controller, or Near-RT RIC 110, beyond processing, the multi-modal LLM 102 plays a role in strategic and policy-based decision-making. Moreover, integrating the multi-modal LLM 102 with the Near-RT RIC 110 aligns the computational intelligence of the multi-modal LLM 102 with the strategic network management orchestrated by the Near-RT RIC 110, so as to help ensure that decisions are not just data-driven but also aligned with the overarching network policies and strategies 112.

### C.3.2 Decoder Part Deployment

### C.3.2.1 Introduction

One aspect of deployment of a decoder, such as the decoder 106, concerns meeting latency requirements for real-time processing. In particular, and given the importance of latency, that is, low latency, in certain tasks, especially those requiring real-time processing, the decoder 106 may be deployed within a Distributed Unit (DU) 114. This proximity to the network environment may help to ensure that the latency is kept to a minimum, which may be important for tasks where even a millisecond is significant in terms of latency.

Another aspect of the deployment of a decoder, concerns leveraging the CU 108 for less time-sensitive tasks. In particular, and in contrast with latency-sensitive operations, when the task at hand is less time-sensitive, the decoder 106 may be positioned within the CU 108. The CU 108, with its more substantial processing power, provides the decoder 106 with the resources that the decoder 106 needs to manage more complex tasks or larger datasets. This placement of the decoder 106 in the CU 108 may be a calculated trade-off, exchanging minimal latency for enhanced computational capabilities, ensuring that the overall efficiency and performance of the system are not simply maintained, but optimized.

As explained above then, the deployment scenarios for both the multi-modal LLM 102 and the decoder 106 exemplify a holistic approach employed in one embodiment. Each component is positioned within the network infrastructure, ensuring that the system integrity, performance, and operational demands are met with precision and foresight.

Moreover, pervasive edge devices 116, often limited by computational resources and power, are an element of an embodiment, at least insofar as they collecting and processing an ever-growing deluge of data. Integrating a portable version of an LLM-based dictionary learning model, such as the multi-modal LLM 102 into these edge devices 116 may enable real-time, on-site data processing, significantly reducing latency, preserving bandwidth, and enhancing data privacy by minimizing the need to transmit sensitive information to the cloud. In an embodiment, this integration is orchestrated, as deploying a portable version of an LLM-based dictionary learning model, such as the multi-modal LLM 102, on pervasive edge devices 106 and synchronizing that multi-modal LLM 102 with a central LLM model in the cloud, or at the edge, may employ an approach that balances computational efficiency, model accuracy, and communication overhead.

### C.3.2.2 Detailed Discussion of a Deployment Approach

As noted above, deploying a portable version of dictionary learning model on pervasive edge devices and synchronizing it with a central LLM model in the cloud or at the edge requires an approach that balances computational efficiency, model accuracy, and communication overhead. The following discussion addresses a strategy, according to one embodiment, to achieve such a deployment.
I. Model Compression for Edge Deployment: To deploy an LLM-based dictionary learning model on resource-constrained edge devices, various model compression techniques may be used.
   Pruning: Remove weights or neurons that contribute the least to the output. Pruning reduces the size of the model with minimal impact on performance.
   Quantization: Reduce the precision of the model parameters, for example, from floating-point to fixed-point representation. This can significantly decrease the model size and speed up computation, especially on hardware that supports efficient fixed-point arithmetic.
   Knowledge Distillation: Train a smaller model (student) to mimic the behavior of a larger, pre-trained model (teacher). The student model learns to replicate the output distributions of the teacher model, achieving similar performance with a fraction of the parameters.
II. Local Training and Inference:
   Initial training: Perform initial training in the cloud to leverage its computational resources, then fine-tune the model locally on edge devices to adapt to specific data distributions or privacy requirements:
   Fine-tuning on Edge: Update the model with local data to capture the unique characteristics of the data at the edge, improving model relevance and performance.
   Inference at the Edge: Run inference locally to reduce latency and bandwidth usage, as well as to maintain data privacy.
III. Synchronization and Model Updates: Establish a synchronization mechanism between the edge devices and the cloud or central edge server to maintain model consistency and improve performance.
   Periodic Synchronization: Regularly synchronize the locally updated models with the central model. This can be done during low network usage periods to minimize impact.
   Delta Updates: Instead of transmitting the entire model, only transmit the updates (deltas) to reduce communication overhead, and latency.
   Federated Learning: Implement a federated learning approach where model updates are aggregated from multiple edge devices to improve the central model while preserving data privacy. Only model updates, not the raw data, are sent by the edge devices to the server.
IV. Handling Model Drift: Monitor the performance of edge models to detect and handle model drift, ensuring that the models remain accurate over time.
   Performance Monitoring: Regularly evaluate model performance on edge devices. If performance degrades, trigger retraining or model updates.
   Adaptive Learning: Implement mechanisms for the model to adapt to changes in data distribution. This may involve continuous learning strategies where the model updates itself in response to new data.
V. Security and Privacy: Ensure that data privacy and model security are maintained during synchronization and model updates.
   Data Encryption: Encrypt data and model updates during transmission to protect against interception and tampering.
   Authentication and Authorization: Implement strict authentication and authorization protocols to ensure that only authorized devices and services can access or update the models.

By employing strategies such as those outlined above, an embodiment may deploy and maintain LLM-based dictionary learning models, such as the Multi-Modal LLM 102, on pervasive edge devices 116, ensuring that those edge devices 116 are efficient, accurate, and in sync with central models in the cloud or at the edge.

### C.4 Glossary of Some Terms

Following are definitions of selected terms used herein. These definitions are not intended to limit the scope of this disclosure, or of any claims, in any way.

| Term | Definition |
|---|---|
| AR | Augmented Reality |
| CNN | Convolutive Neural Network |
| CS | Compressed Sensing |
| CU | Central Unit |
| DCT | Discrete Cosine Transform |
| DU | Distributed Unit |
| LLM | Large Language Model |
| MFCC | Mel-Frequency Cepstral Coefficients |
| Near-RT RIC | Near-Real Time RAN Intelligent Controller |
| Non-RT RIC | Non-Real Time RAN Intelligent Controller |
| RAN | Radio Access Network |
| RIP | Restricted Isometry Property |
| SCC | Sensing, Compute and Communication |
| VR | Virtual Reality |
| WT | Wavelet Transform |

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

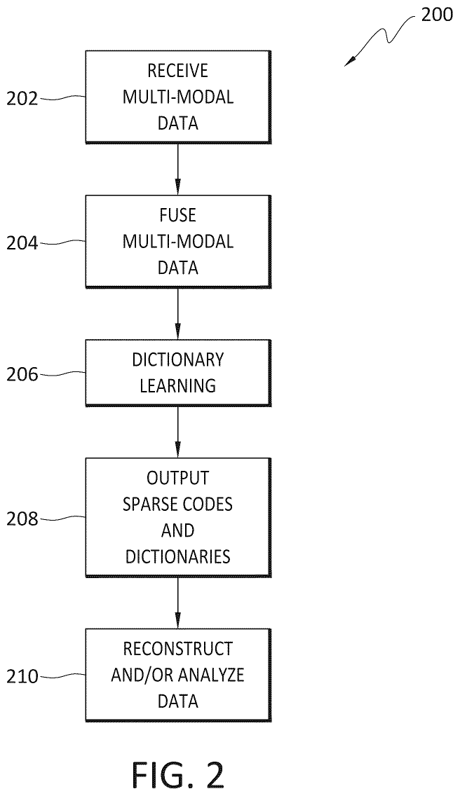

Directing attention now to FIG. 2, a method 200 according to one embodiment is disclosed. The method 200 may be performed in connection with a network that includes various devices, such as edge devices, of different types, and which each generate and/or collect different respective types of data. In an embodiment, part, or all, of the method 200 may be performed, such as by a multi-modal LLM, at each of one or more edge devices of a network. As well, the method 200 may be performed recursively and/or on an ongoing basis.

The example method 200 may begin with the collection of multi-modal data, comprising various different data types, which may be received 202 from different respective types of edge devices of a network. Some or all of the collected multi-modal data may be subjected to various pre-processing operations, and/or feature extraction operations.

The multi-modal data may then be fused together 204. The fused data may then be provided as input to a multi-modal LLM configured and operable to handle high-dimensional multi-modal data. The multi-modal LLM may then perform a dictionary learning process 206 that comprises learning a respective sparsifying dictionary for each different data type of the multi-modal data, and/or learning a combined dictionary for the fused data. The dictionaries may contain elements which, when combined in a sparse manner, may be used to reconstruct the input multi-modal data.

Next, the multi-modal LLM may output 208 both the learned dictionaries, and sparse codes for the input multi-modal data. These sparse codes comprise representations that capture the core elements and information from the multi-modal data. The dictionaries and/or the sparse codes may then be used to reconstruct 210 the original data received from the edge devices, and/or may be used to perform various analyses on that original data.

### E. Further Example Embodiments

Following are some further example embodiments. These are presented only by way of example and are not intended to limit the scope of this disclosure or the claims in any way.

Embodiment 1. A method for training a model to represent and use multiple different data types, comprising: receiving multi-modal data that comprises different respective types of data from different respective devices of a network; fusing the multi-modal data together to generate fused data; providing the fused data to a multi-modal LLM (large language model); learning, by the multi-modal LLM, one or more sparsifying dictionaries for the multi-modal data and/or the fused data; generating, by the multi-modal LLM, sparse codes corresponding to the multi-modal data; and using the sparsifying dictionaries and sparse codes to reconstruct the multi-modal data initially received, and/or to perform one or more analyses on the multi-modal data.

Embodiment 2. The method as recited in any preceding embodiment, wherein the multi-modal data comprises any combination of two or more of visual data, audio data, sensor data, and biometric data.

Embodiment 3. The method as recited in any preceding embodiment, wherein some of the multi-modal data is subjected to pre-processing and/or feature extraction prior to generation of the fused data.

Embodiment 4. The method as recited in any preceding embodiment, wherein the receiving of the multi-modal data comprises sampling the multi-modal data below a Nyquist rate.

Embodiment 5. The method as recited in any preceding embodiment, wherein a RIP (restricted isometry property) constraint is applied in the learning of the one or more sparsifying dictionaries to guide the multi-modal LLM to learn the sparsifying dictionaries that satisfy the RIP constraint.

Embodiment 6. The method as recited in any preceding embodiment, wherein Lipschitz Continuity is applied as a constraint in the learning of the one or more sparsifying dictionaries.

Embodiment 7. The method as recited in any preceding embodiment, wherein the one or more sparsifying dictionaries comprise either a single sparsifying dictionary for the fused data, or respective sparsifying dictionaries for each of the types of data.

Embodiment 8. The method as recited in any preceding embodiment, wherein the one or more analyses comprise anomaly detection and/or pattern recognition.

Embodiment 9. The method as recited in any preceding embodiment, wherein a regularization technique is applied in a fine tuning phase of the learning of the one or more sparsifying dictionaries.

Embodiment 10. The method as recited in any preceding embodiment, wherein each of the one or more sparsifying dictionaries comprises atoms that, when combined in a sparse manner, reconstruct the multi-modal data that was received initially.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

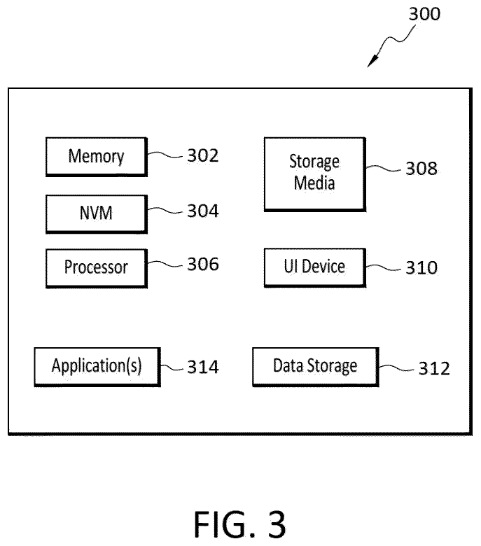

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for training a model to represent and use multiple different data types, comprising:
receiving multi-modal data that comprises different respective types of data from different respective devices of a network;
fusing the multi-modal data together to generate fused data;
providing the fused data to a multi-modal LLM (large language model);
learning, by the multi-modal LLM, one or more sparsifying dictionaries for the multi-modal data and/or the fused data;
generating, by the multi-modal LLM, sparse codes corresponding to the multi-modal data; and
using the sparsifying dictionaries and sparse codes to reconstruct the multi-modal data initially received, and/or to perform one or more analyses on the multi-modal data.

2. The method as recited in claim 1, wherein the multi-modal data comprises any combination of two or more of visual data, audio data, sensor data, and biometric data.

3. The method as recited in claim 1, wherein some of the multi-modal data is subjected to pre-processing and/or feature extraction prior to generation of the fused data.

4. The method as recited in claim 1, wherein the receiving of the multi-modal data comprises sampling the multi-modal data below a Nyquist rate.

5. The method as recited in claim 1, wherein a RIP (restricted isometry property) constraint is applied in the learning of the one or more sparsifying dictionaries to guide the multi-modal LLM to learn the sparsifying dictionaries that satisfy the RIP constraint.

6. The method as recited in claim 1, wherein Lipschitz Continuity is applied as a constraint in the learning of the one or more sparsifying dictionaries.

7. The method as recited in claim 1, wherein the one or more sparsifying dictionaries comprise either a single sparsifying dictionary for the fused data, or respective sparsifying dictionaries for each of the types of data.

8. The method as recited in claim 1, wherein the one or more analyses comprise anomaly detection and/or pattern recognition.

9. The method as recited in claim 1, wherein a regularization technique is applied in a fine tuning phase of the learning of the one or more sparsifying dictionaries.

10. The method as recited in claim 1, wherein each of the one or more sparsifying dictionaries comprises atoms that, when combined in a sparse manner, reconstruct the multi-modal data that was received initially.

11. A non-transitory storage medium having stored therein instructions that are executable by one or more hardware processors to perform operations comprising:
receiving multi-modal data that comprises different respective types of data from different respective devices of a network;
fusing the multi-modal data together to generate fused data;
providing the fused data to a multi-modal LLM (large language model);
learning, by the multi-modal LLM, one or more sparsifying dictionaries for the multi-modal data and/or the fused data;
generating, by the multi-modal LLM, sparse codes corresponding to the multi-modal data; and
using the sparsifying dictionaries and sparse codes to reconstruct the multi-modal data initially received, and/or to perform one or more analyses on the multi-modal data.

12. The non-transitory storage medium as recited in claim 11, wherein the multi-modal data comprises any combination of two or more of visual data, audio data, sensor data, and biometric data.

13. The non-transitory storage medium as recited in claim 11, wherein some of the multi-modal data is subjected to pre-processing and/or feature extraction prior to generation of the fused data.

14. The non-transitory storage medium as recited in claim 11, wherein the receiving of the multi-modal data comprises sampling the multi-modal data below a Nyquist rate.

15. The non-transitory storage medium as recited in claim 11, wherein a RIP (restricted isometry property) constraint is applied in the learning of the one or more sparsifying dictionaries to guide the multi-modal LLM to learn the sparsifying dictionaries that satisfy the RIP constraint.

16. The non-transitory storage medium as recited in claim 11, wherein Lipschitz Continuity is applied as a constraint in the learning of the one or more sparsifying dictionaries.

17. The non-transitory storage medium as recited in claim 11, wherein the one or more sparsifying dictionaries comprise either a single sparsifying dictionary for the fused data, or respective sparsifying dictionaries for each of the types of data.

18. The non-transitory storage medium as recited in claim 11, wherein the one or more analyses comprise anomaly detection and/or pattern recognition.

19. The non-transitory storage medium as recited in claim 11, wherein a regularization technique is applied in a fine tuning phase of the learning of the one or more sparsifying dictionaries.

20. The non-transitory storage medium as recited in claim 11, wherein each of the one or more sparsifying dictionaries comprises atoms that, when combined in a sparse manner, reconstruct the multi-modal data that was received initially.
